(19) United States
(12) Patent Application Publication
(10) Pub. No.: US 2007/0236785 A1
(43) Pub. Date: Oct. 11, 2007

(54) Microscope

(75) Inventor: Yusuke Matsumoto, Hachioji-shi (JP)

Correspondence Address: Scully, Scott, Murphy & Presser, 400 Garden City Plaza, Garden City, NY, 11530-3319, US

(73) Assignee: Olympus Corporation, Tokyo (JP)

(21) Appl. No.: 11/728,790

(22) Filed: Mar. 27, 2007

(30) Foreign Application Priority Data
Mar. 29, 2006 (JP) 2006-092070
Mar. 6, 2007 (JP) 2007-056080

(51) Int. Cl. G02B 21/00

(52) U.S. Cl. 359/381; 359/368

(57) ABSTRACT

A microscope includes an objective lens and a microscope body to support the objective lens. The microscope body has inside a hollow portion. The microscope further includes an illumination unit including an illumination optical system to apply illumination light to a sample in cooperation with the objective lens and an inserting/removing mechanism to insert/remove the illumination unit in/from the hollow portion.

### CROSS-REFERENCE TO RELATED APPLICATIONS

This application is based upon and claims the benefit of priority from prior Japanese Patent Applications No. 2006-092070, filed Mar. 29, 2006; and No. 2007-056080, filed Mar. 6, 2007, the entire contents of both of which are incorporated herein by reference.

### BACKGROUND OF THE INVENTION

1. Field of the Invention

The present invention relates to a microscope with an illumination optical system.

2. Description of the Related Art

As a conventional microscope with an illumination optical system, a microscope using Koehler illumination like that shown in FIG. 17 is known. Referring to FIG. 17, a microscope body 10 has a horizontal U shape as viewed from a side surface, and comprises three portions, i.e., a base portion 10a, a support portion 10b extending upward from one end of the base portion 10a (the right end in FIG. 17), and an arm portion 10c horizontally extending from the upper end of the support portion 10b while facing the base portion 10a. The arm portion 10c includes an illumination optical system 16 including a light source 1, a projection lens 13, a aperture stop 2, a field stop 3, and an illumination lens 4. The illumination optical system 16 forms Koehler illumination, in which the light source 1, the aperture stop 2, and the exit pupil of an objective lens 7 have a conjugate relationship, and the field stop 3 and a sample 9 also have a conjugate relationship. For bright field observation, a bright field cube 5 is placed on the distal end portion of the arm portion 10c.

In this state, illumination light emitted from the light source 1 passes through the projection lens 13, aperture stop 2, field stop 3, and illumination lens 4, to reach the bright field cube 5. The bright field cube 5 includes a half mirror 5a serving as an optical path splitting element. The half mirror 5a reflects (partially transmits) the illumination light from the light source 1 passing through an illumination optical path n toward the sample 9. The reflected light illuminates the sample 9 placed on a stage 8 through the objective lens 7. Objective lenses having different magnifications are attached to a nosepiece 6. The objective lens 7 having a desired magnification is placed on the optical path. The stage 8 is allowed to move up and down by rotating the focusing handle 14. Observation light from the sample 9, i.e., returning light from the sample 9, passes through the objective lens 7, is transmitted (partially reflected) through the half mirror 5a, and then visually observed by an observer through a observation tube 11 and an eyepiece 12 located above the arm portion 10c.

In such a microscope, the illumination optical system 16 and the bright field cube 5, which are enclosed by the dotted line in FIG. 17, is changed corresponding to the type of observation method used. For example, the entire portion enclosed by the dotted line in FIG. 17, i.e., the projection tube unit is changed, or components such as the light source 1 and the bright field cube 5 are individually changed.

However, changing a component such as a light source or cube corresponding to each type of observation method used in this manner requires attaching and detaching components for every component changing operation. This is cumbersome for the observer and causes deterioration in the efficiency of microscopic observation.

Some users use such microscopes for the examination of wafers used for semiconductor elements and glass substrates called master substrates used for liquid crystal panels. Recently, the manufacturing process for semiconductor elements tends to use large-size wafers in order to produce many chips, ICs, or the like from one wafer for the improvement of productivity. In addition, with the upsizing of liquid crystal panels, glass substrates have increased in size. In order to directly place a sample such as a large-size wafer or glass substrate on the stage for microscopic examination of such a large-size sample, it is necessary to change the depth dimension (depth) of the microscope body 10 in accordance with the size of the stage. This requires preparing arm portions having different lengths as the arm portion 10c, which horizontally extends along the base portion 10a. For this reason, in the illumination optical system 16 having the light source 1 placed on the proximal end side of the arm portion 10c, use of the arm portions having different lengths will change the positional relationship between lenses and the projection magnification of a light source image with respect to the objective lens 7. This leads to cumbersome adjustment.

As disclosed in Jpn. Pat. Appln. KOKAI Publication No. 6-51204, as a technique of solving such an inconvenience, it is conceivable to use an arrangement in which a microscope body is divided into units to allow selection of a base, horizontal U-shaped support, and projection tube portion in accordance with the stage size, and that copes with a large-size sample by properly combining them without changing the optical performance.

The arrangement disclosed in Jpn. Pat. Appln. KOKAI Publication No. 6-51204, however, needs to ensure rigidity for each divided unit, and hence each unit inevitably increases in weight and size. In addition, since the respective units are connected by screw fixing, rigidity of each unit in the connected state is ensured by the rigidity of each screw itself. For this reason, it is necessary to use a sufficient number of screws with sufficiently large diameters and ensure large thickness for the screw joining portions between the respective units. This causes a further increase in weight and imposes restriction on the degree of freedom of design. In addition, fixing the respective units by using screws requires attaching and detaching screws every time each unit is changed to another unit. This is cumbersome operation for the operator. Furthermore, this may cause deterioration in operation efficiency.

In addition, when, for example, an autofocus (AF) unit is stacked on the projection tube unit, the height dimension of the overall structure increases by the thickness of the stacked AF unit and the thickness of a dovetail or the like for joining the AF unit on the projection tube unit. This increases the length of the optical path through which observation light from a sample is formed into an image on the eyepiece or image sensing device, and may cause a shortage of the marginal light amount of an observation image. Furthermore, an increase in the length of the optical path will raise the position of the eyepiece barrel, resulting in raising the eyepoint. The eyepoint is the viewing position of the observer. If the eyepoint changes every time the manner of using the microscope changes, an unnecessary burden is placed on the observer. That is, it is preferable for the observer to keep the eyepoint unchanged.

### BRIEF SUMMARY OF THE INVENTION

A microscope according to an aspect of the present invention includes an objective lens and a microscope body to support the objective lens. The microscope body has inside a hollow portion. The microscope further includes an illumination unit including an illumination optical system to apply illumination light onto a sample in cooperation with the objective lens and an inserting/removing mechanism to insert/remove the illumination unit in/from the hollow portion.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view showing the schematic arrangement of a microscope according to the first embodiment of the present invention;

FIG. 2 is a partial sectional view schematically showing the front main part of the microscope according to the first embodiment;

FIG. 3 is a side view showing the schematic arrangement of an illumination unit used to a microscope according to the second embodiment of the present invention;

FIG. 4 is a partial top view showing the schematic arrangement of an illumination unit used to the microscope according to the second embodiment;

FIGS. 5A, 5B, and 5C show a cube fixing method applied to the illumination unit according to the second embodiment;

FIGS. 6A, 6B, and 6C show the schematic arrangement of an illumination unit according to the third embodiment of the present invention;

FIG. 7 is a side view showing the schematic arrangement of a microscope according to the fourth embodiment of the present invention;

FIG. 8 is a partial sectional view schematically showing the front main part of the microscope according to the fourth embodiment;

FIG. 9A shows the schematic arrangement of a modification of the fourth embodiment of the present invention;

FIG. 9B shows the schematic arrangement of another modification of the fourth embodiment of the present invention;

FIG. 10 shows the schematic arrangement of still another modification of the fourth embodiment of the present invention;

FIG. 11 is a partial sectional view showing the front main part of a microscope according to the fifth embodiment of the present invention;

FIG. 12 shows the schematic arrangement of a modification of the fifth embodiment of the present invention;

FIG. 13 shows the schematic arrangement of another modification of the fifth embodiment of the present invention;

FIG. 14 shows the schematic arrangement of still another modification of the fifth embodiment of the present invention;

FIG. 15 shows the schematic arrangement of further another modification of the fifth embodiment of the present invention;

FIG. 16 is a side view showing the schematic arrangement of a microscope according to the sixth embodiment of the present invention; and

FIG. 17 shows the schematic arrangement of a conventional microscope.

### DETAILED DESCRIPTION OF THE INVENTION

The embodiments of the present invention will be described below with reference to the views of the accompanying drawing.

### First Embodiment

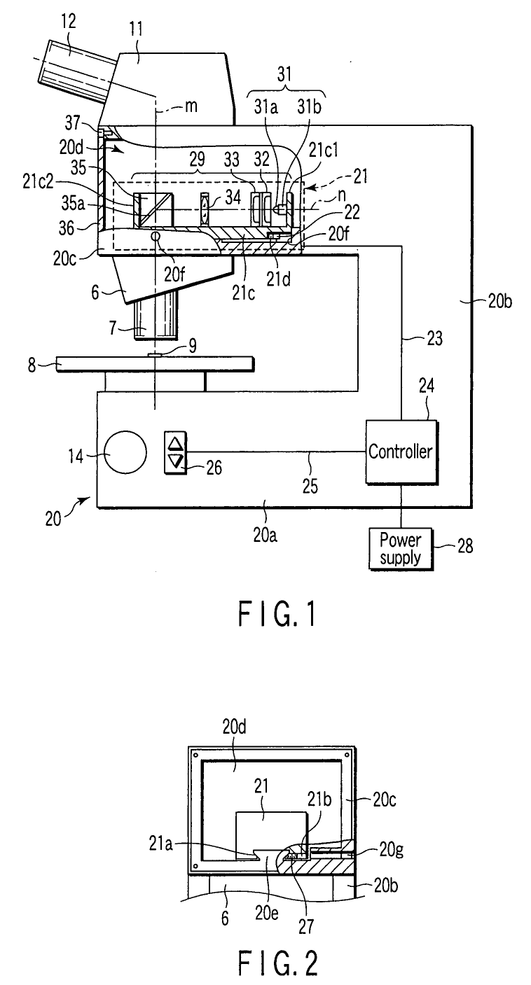

FIGS. 1 and 2 show the schematic arrangement of a microscope according to the first embodiment of the present invention, FIG. 1 is a side view of the microscope, and FIG. 2 is a partial sectional view of the front main part of the microscope. A description of the same part as that shown in FIG. 17 described above will be omitted, and different points between these microscopes will be described with reference to FIGS. 1 and 2.

Referring to FIG. 1, a microscope body 20, which has a horizontal U shape as viewed from a side surface, comprises three portions, i.e., a base portion 20a that is placed on a horizontal installation surface, a support portion 20b extending upward from one end of the base portion 20a (the right end in FIG. 1), and an arm portion 20c horizontally extending from the upper end of the support portion 20b while facing the base portion 20a. The arm portion 20c has inside a hollow portion 20d. The hollow portion 20d horizontally extends from the distal end face of the arm portion 20c toward the support portion 20b while facing the base portion 20a.

The hollow portion 20d of the arm portion 20c is provided with a male dovetail 20e (see FIG. 2). The male dovetail 20e is formed on the bottom surface of the hollow portion 20d so as to extend along the longitudinal direction (an illumination optical path n to be described later) of the hollow portion 20d. An illumination unit 21 is detachably mounted in the hollow portion 20d. The illumination unit 21 is provided with the female dovetail 21a. The male dovetail 20e is fitted in the female dovetail 21a. The female dovetail 21a and the male dovetail 20e constitute an inserting/removing mechanism for inserting/removing the illumination unit 21 in/from the arm portion 20c. This inserting/removing mechanism allows the illumination unit 21 to be inserted and removed by sliding operation of the illumination unit 21 with respect to the hollow portion 20d. The hollow portion 20d has inside a stepped portion having an abutment surface 20f. The illumination unit 21 inserted in the hollow portion 20d abuts against the abutment surface 20f to position the illumination unit 21 at the position where the illumination optical path n of the illumination optical system 29 intersects an observation optical path m passing through the objective lens 7. The abutment surface 20f constitutes a positioning mechanism for positioning the illumination unit 21.

The hollow portion 20d of the arm portion 20c is provided with a connector portion 22 near the abutment surface 20f. When the illumination unit 21 is positioned by abutting against the abutment surface 20f, the connector portion 22 is connected to the connector portion 21d on the illumination unit 21. The connector portion 22 is connected to a controller 24 through a cable 23. The controller 24 is connected to a power supply 28 and also connected to a light control button 26 through a cable 25. The controller 24 controls ON/OFF of a light source 31 (LED 31a) (to be described later) of the illumination unit 21 in accordance with the operation of a power switch (not shown), and also controls brightness by adjusting the power supplied from the power supply 28 to the light source 31 in accordance with the operation of the light control button 26 by the observer. The power supply 28 is desirably placed in an area where heat has little effect on the microscope or a position where there is no need to consider the influence of heat. The light control button 26 is preferably placed near the operating portion, e.g., a position behind a focusing handle 14, in consideration of the operability of the microscope body 20 by the observer. The controller 24 and the cables 23 and 25 are properly located in a place where there is no influence on the microscope performance.

A side wall of a female dovetail 21a of the illumination unit 21 is provided with a screw hole 21b (see FIG. 2). The screw hole 21b extends to the male dovetail 20e through the side wall of the female dovetail 21a. A detachable screw 27 as a fastener is threaded into the screw hole 21b, and the distal end of the detachable screw 27 presses a side surface of the male dovetail 20e, thereby fixing the illumination unit 21 positioned by the abutment surface 20f. The detachable screw 27 and the screw hole 21b constitute a fixing mechanism for fixing the illumination unit 21 on the arm portion 20c.

As shown in FIG. 2, a side wall of the arm portion 20c is provided with a hole portion 20g to communicate with the screw hole 21b. The hole portion 20g is for inserting the detachable screw 27 and a tool (not shown) for fastening the detachable screw 27.

The illumination unit 21 has a frame body 21c that is inserted in and removed from the arm portion 20c. The frame body 21c is provided with, on two end portions along the illumination optical path n, a pair of protruding walls 21c1 and 21c2 facing each other, and has a U-shaped cross-section. On the bottom portion of the frame body 21c, which is located between the pair of protruding walls 21c1 and 21c2, a light source 31, a aperture stop 32, a field stop 33, a bright field illumination lens 34, and a bright field cube 35, which constitute an illumination optical system 29, are arranged along the illumination optical path n, thereby forming a bright field observation illumination unit. The light source 31 includes the LED 31a as a semiconductor light-emitting element and a socket 31b provided on the protruding wall 21c1. The LED 31a is attached to the socket 31b by, for example, a threading scheme, and is positioned while being threaded into the end of the socket 31b. The LED 31a is positioned near the aperture stop 32. Positioning the LED 31a to the socket 31b determines the mount position of the LED 31a. This allows the LED 31a to be replaced when, for example, it is inspected or fails. The light source 31 may include LEDs and a single substrate on which they are mounted and be positioned and fixed with the substrate fixed by an attaching/detaching mechanism (not shown) provided on the socket 31b or protruding wall 21c1. The socket 31b electrically is connected to the connector portion 21d. While the connector portion 21d is connected to the connector portion 22 on the hollow portion 20d side, the controller 24 controls ON/OFF of the LED 31a and brightness. While the illumination unit 21 is positioned by the abutment surface 20f, the illumination optical system 29 forms Koehler illumination, in which the light source 31, the aperture stop 32, and the exit pupil of the objective lens 7 are positioned to have a conjugate relationship, and the field stop 33 and a sample 9 are positioned to have a conjugate relationship. In this state, illumination light emitted from the light source 31 (LED 31a) passes through the aperture stop 32, the field stop 33, and the bright field illumination lens 34, to reach the bright field cube 35. The bright field cube 35, which includes a half mirror 35a, reflects (partially transmits) the illumination light passing through the illumination optical path n toward the sample 9, which illuminates the sample 9 placed on the stage 8 through the objective lens 7. Observation light from the sample 9, i.e., returning light from the sample 9, passes through the objective lens 7, is transmitted (partially reflected) through the half mirror 35a, and then visually observed by an observer through a observation tube 11 and an eyepiece 12 located above the arm portion 20c.

The arm portion 20c of the microscope body 20 is provided with a cover 36 to cover the opening portion of the hollow portion 20d. The cover 36, which is removed when inserting/removing the illumination unit 21 in/from the hollow portion 20d, is normally fixed with a screw 37.

In the present embodiment, the bright field observation illumination unit has been described as the illumination unit 21. However, illumination units corresponding to various kinds of observation methods are prepared: a fluorescence observation illumination unit, differential interference observation illumination unit, dark field observation illumination unit, phase difference observation illumination unit, and the like. Each of these illumination units includes a frame body having the same shape as that of the frame body 21c of the illumination unit 21, and also includes an illumination optical system and an optical element such as a cube corresponding to the type of observation method used, which are held by the frame body. For example, for fluorescence observation, a mercury lamp or a semiconductor light-emitting element such as an LED having a specific wavelength is used as a light source, and a fluorescence observation illumination unit, which is designed to switch fluorescence cubes corresponding to specific wavelengths, is also used instead of the bright field cube 35. For differential interference observation, a differential interference illumination unit, which has a differential interference cube including an analyzer and a polarizer, is used instead of the bright field cube 35. For differential interference observation, an arrangement designed to insert a DIC slider from a nosepiece 6 into an optical path is needed. Illumination units corresponding to these types of observation methods are configured to have compatibility with respect to the positional relationship between the illumination unit 21 and the abutment surface 20f and the positional relationship between the connector portions 21d and 22. Assume that the arm portions 20c of the microscope bodies 20 of microscopes have different heights or widths. Even in this case, making the hollow portions 20d of the arm portions 20c have a common structure allows the illumination units corresponding to the respective types of observation methods to be commonly used. This eliminates the necessity to design dedicated illumination units.

The operation of the embodiment having the above arrangement will be described next.

A case wherein the illumination unit 21 for bright field observation described above is to be mounted will be described first. In this case, the cover 36 covering the opening of the hollow portion 20d of the arm portion 20c is removed, the male dovetail 20e on the hollow portion 20d side is fitted in the female dovetail 21a of the illumination unit 21, and the illumination unit 21 is slid to be pushed. This sliding operation abuts the illumination unit 21 against the abutment surface 20f and positions the illumination unit 21 within the hollow portion 20d. In this state, the connector portion 21d of the illumination unit 21 is connected to the connector portion 22, so that the LED 31a in the illumination unit 21 is connected to the controller 24 through the cable 23. With the illumination unit 21 positioned, a tool (not shown) is inserted into the hole portion 20g of the side wall of the arm portion 20c to fasten the detachable screw 27, so that the illumination unit 21 is fixed inside the hollow portion 20d. Thereafter, the opening of the hollow portion 20d is covered with the cover 36, which is fixed to the arm portion 20c with the screw 37.

In this state, bright field observation is available. In this case, the controller 24 turns on the LED 31a of the light source 31, and controls brightness in accordance with the operation of the light control button 26. Light from the LED 31a passes through the aperture stop 32, the field stop 33, and the bright field illumination lens 34, to reach the bright field cube 35. The light is reflected (partially transmitted) by the half mirror 35a toward the sample 9, and illuminates the sample 9 placed on the stage 8 through the objective lens 7. Observation light from the sample 9 (returning light from the sample 9) passes through the objective lens 7, is transmitted (partially reflected) through the half mirror 35a, and then visually observed by an observer through the observation tube 11 and eyepiece 12 located above the arm portion 20c.

Thereafter, removal of the illumination unit 21 is operated by the reverse procedure to that described above.

For changing the LED 31a of the light source 31, the illumination unit 21 is removed from the arm portion 20c, the LED 31a is then removed from the socket 31b by rotating the LED 31a, and a new LED 31a is attached to the socket 31b by screwing the LED 31a to the end.

For observing a sample by one of various kinds of observation methods, e.g., fluorescence observation, differential interference observation, dark field observation, and phase difference observation, instead of bright field observation, a desired illumination unit is selected from a fluorescence observation illumination unit, differential interference observation illumination unit, dark field observation illumination unit, and phase difference observation illumination unit prepared in advance in correspondence with these observation methods, and the selected illumination unit is mounted in the hollow portion 20d of the arm portion 20c instead of the illumination unit 21. The inserting/removing procedures for these illumination units are the same as those for the bright field observation illumination unit 21 described above.

In this embodiment, since the arm portion 20c of the microscope body 20 has the hollow portion 20d, the illumination unit 21 obtained by forming an illumination optical system into a unit is inserted in and removed from the hollow portion 20d, and the illumination unit 21 is selected from various kinds of illumination units including the bright field observation illumination unit, fluorescence observation illumination unit, differential interference observation illumination unit, dark field observation illumination unit, phase difference observation illumination unit, and the like, a microscope suitable for each of various kinds of observation methods is constructed. This greatly improves the degree of freedom of microscopic observation for the user. In addition, this arrangement is configured to hold the illumination unit 21 by only the arm portion 20c of the microscope body 20 for which a certain degree of rigidity is ensured unlike the conventional arrangement configured to ensure rigidity for each of the divided units, combine the units, and fix them with screws for which sufficient rigidity is ensured. This allows the overall weight and size of the microscope to be reduced. Since it is unnecessary for the operator to attach and detach many screws to fix units as in the prior art, the operator can form microscopes suitable for various kinds of observation methods by simple operation without troublesome work. Furthermore, preparing illumination units corresponding to various kinds of observation methods can save troublesome work of changing the illumination optical system in accordance with an observation method.

Using a light source using a discharge lamp such as a halogen lamp or xenon lamp as in the prior art will cause thermal expansion of the microscope body and the like due to the influence of large heat generated by light emission and often accompanies part replacement because such a lamp is a consumable product. So, it is difficult to incorporate a light source in a microscope body. A light source such as a halogen lamp or mercury-xenon lamp is provided in a lamp house placed behind the microscope body. In addition, it is necessary to also consider the generation of heat by a light source portion for such a light source, and hence the light source is generally placed in a rear portion of the microscope. In contrast to this, the microscope of this embodiment uses the LED 31a, which is a semiconductor light-emitting element, as the light source 31, and hence it generates only a small amount of heat. This greatly reduces a rise in the temperature of the microscope body as compared with the conventional microscope using a light source such as a halogen lamp. In addition, the power supply 28 of the light source 31 is placed outside the illumination unit 21, and power is supplied from outside the illumination unit 21. This makes it difficult to cause problems due to the generation of heat. In addition, positioning the LED 31a on the optical axis within the illumination unit 21 in advance reduces the load of cumbersome work of performing optical axis adjustment after mounting a light source in a microscope body as in the prior art. Furthermore, even in the use of different microscopes with microscope bodies having different heights or widths, making the hollow portions 20d of the arm portions 20c have a common structure allows to commonly use an illumination unit corresponding to each type of observation method. This eliminates the necessity to design any dedicated illumination unit, and provides high convenience for the manufacturer and advantages in terms of cost.

In the above manner, a microscope that can perform observation with high work efficiency for the user is provided.

In the above embodiment, the inserting/removing mechanism for inserting/removing the illumination unit 21 in/from the arm portion 20c is constructed by the dovetail mechanism comprising the male dovetail 20e and the female dovetail 21a. However, the present invention is not limited to this. For example, this mechanism may be constructed by other positioning/fixing techniques, e.g., providing a mechanical reference surface on the inner wall of the hollow portion 20d of the arm portion 20c and fixing the illumination unit 21 with a screw and using a known guiding mechanism. In addition, the shape of the frame body 21c of the illumination unit 21 is not limited to that described above, and may be a box-like shape or a tubular shape such as a cylindrical shape. Furthermore, the above embodiment has the arrangement in which the illumination unit 21 integrally incorporates the light source 31. It, however, suffices to use an arrangement in which the light source 31 is placed on the illumination optical path n of the hollow portion 20d of the arm portion 20c separately from the illumination unit 21, and optical elements other than the light source 31 are placed on the frame body 21c of the illumination unit 21. This arrangement makes the light source common to illumination units corresponding to various kinds of observation methods, and hence provides further advantages in terms of cost. In this case, it suffices to fix the aperture stop 32, field stop 33, and light source 31 on the hollow portion 20d side of the arm portion 20c so as to make the resultant structure common to illumination units corresponding to various kinds of observation methods.

### Second Embodiment

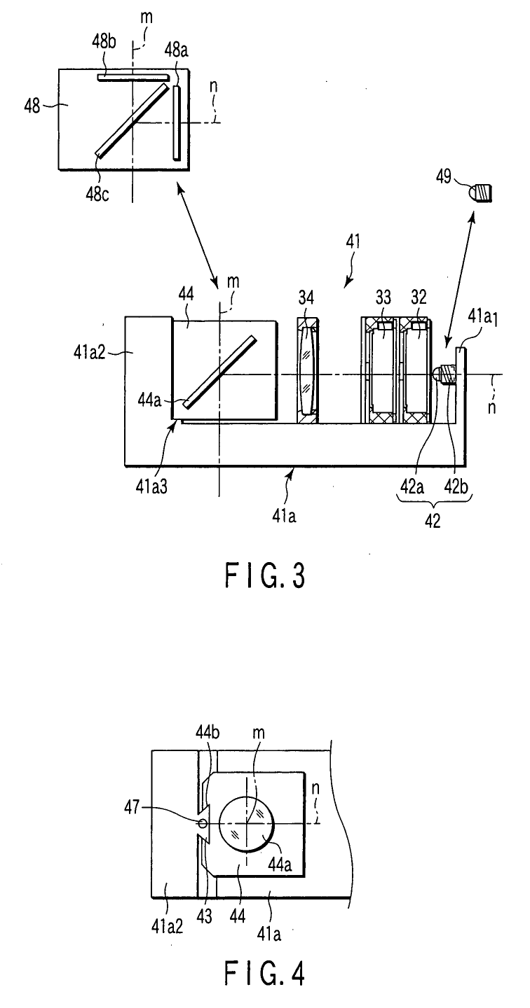

FIG. 3 is a side view of an illumination unit used to a microscope according to the second embodiment of the present invention. FIG. 4 is a top view of part of the illumination unit. A description of the same part as that of the first embodiment described above will be omitted, and only different points between these embodiments will be mainly described with reference to FIGS. 3 and 4.

An illumination unit 41 has a frame body 41a that is inserted in and removed from an arm portion 20c. The frame body 41a is provided with, on two end portions along an illumination optical path n, a pair of protruding walls 41a1 and 41a2 facing each other. The protruding wall 41a1 of the frame body 41a is provided with a light source 42. The light source 42 comprises a socket 42b provided on the protruding wall 41a1 and an LED 42a attached to the socket 42b by a threading scheme. This embodiment allows switching of various kinds of LEDs 42a corresponding to observation methods.

Various kinds of cubes in accordance with the observation methods can be attached to the protruding wall 41a2 of the frame body 41a. As shown in FIG. 4, a side surface of the protruding wall 41a2 is provided with a male dovetail 43. The male dovetail 43 extends in the direction of an observation optical path m passing through an objective lens 7. The male dovetail 43 is attached to a bright field cube 44 having a half mirror 44a used for bright field observation. The bright field cube 44 is provided with a female dovetail 44b on a side surface corresponding to the protruding wall 41a2. The female dovetail 44b is fitted on the male dovetail 43, so that the bright field cube 44 is inserted and removed by sliding operation. The proximal end portion of the protruding wall 41a2 is provided with a stepped portion having an abutment surface 41a3. The bright field cube 44 inserted along the male dovetail 43 is abutted against the abutment surface 41a3 to be positioned. The abutment surface 41a3 forms a positioning mechanism for positioning the bright field cube 44.

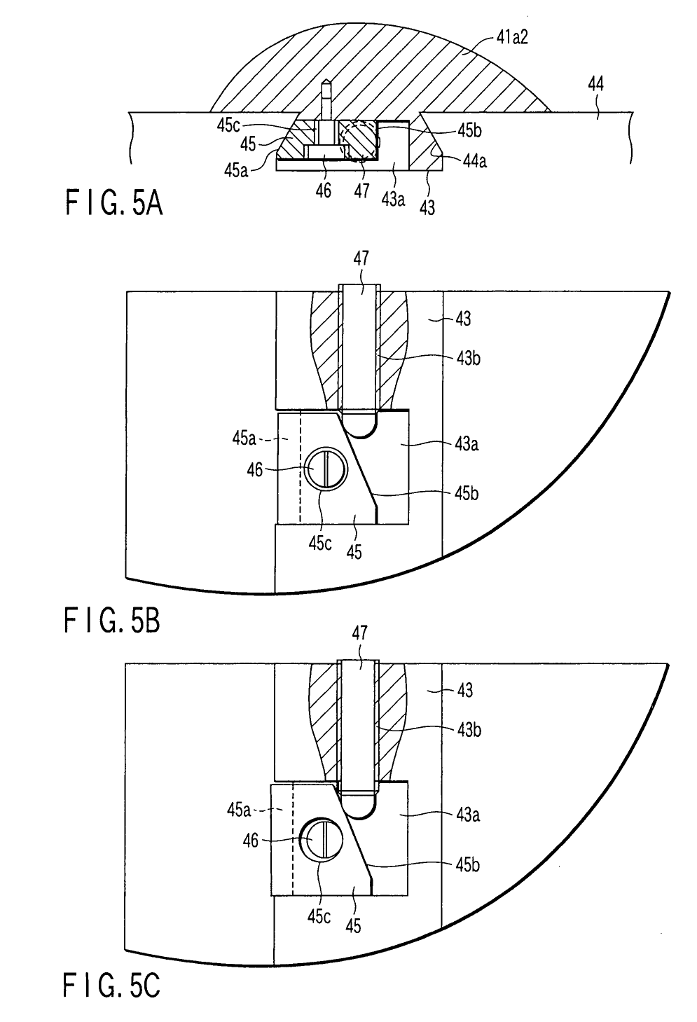

As shown in FIGS. 5A, 5B, and 5C, the male dovetail 43 is provided with a notched portion 43a. A fixing member 45 is placed in the notched portion 43a. One side surface of the fixing member 45 is formed into a tapered surface 45a with the same inclination as that of a side surface of the male dovetail 43, and the other side surface is formed into a tapered surface 45b for positional adjustment. The fixing member 45 is fixed to the bottom surface of the notched portion 43a with a set screw 46. A hole portion 45c that allows insertion of the set screw 46 of the fixing member 45 has a diameter larger than that of the set screw 46, so that the fixing member 45 can protrude from a side surface of the male dovetail 43 by the diameter difference. The male dovetail 43 is provided with a threaded portion 43b extending through from its end face to the notched portion 43a. A detachable screw 47 is threaded into the threaded portion 43b. The distal end of the detachable screw 47 is in contact with the tapered surface 45b of the fixing member 45. When the detachable screw 47 is threaded into the threaded portion 43b, the tapered surface 45a of the fixing member 45 protrudes from a side surface of the male dovetail 43 and presses a side surface of the female dovetail 44b of the bright field cube 44, thereby positioning and fixing the bright field cube 44. The fixing member 45, detachable screw 47, and threaded portion 43b constitute an attaching/detaching mechanism for attaching/detaching the cube 44 or a cube 48 to/from the frame body 41a.

The remaining arrangement is the same as that of the first embodiment.

The operation of the second embodiment having the above arrangement will be described next.

A case wherein the bright field cube 44 is attached to the illumination unit 41 will be described first. In this case, the male dovetail 43 on the side surface of the protruding wall 41a2 of the frame body 41a is fitted in the female dovetail 44b of the bright field cube 44, and the bright field cube 44 is slid so as to be pushed. With this sliding operation, the bright field cube 44 abuts against the abutment surface 41a3 and is positioned inside the illumination unit 41. In this state, fastening the detachable screw 47 will position and fix the bright field cube 44. As the light source 42, the LED 42a corresponding to bright field observation is attached to the socket 42b.

For performing, for example, fluorescence observation instead of bright field observation, the bright field cube 44 is removed by the reverse procedure to that described above, and the bright field cube 44 is replaced with the fluorescence observation cube 48. The fluorescence observation cube 48 includes an excitation filter 48a, absorption filter 48b, and dichroic mirror 48c, and is provided with a female dovetail (not shown) similar to that of the bright field cube 44.

The procedure of attaching/detaching the fluorescence observation cube 48 to/from the illumination unit 41 is the same as that for the bright field cube 44 described above. In addition, an LED 49 corresponding to fluorescence observation is attached to the socket 42b instead of the LED 42a for bright field observation, to form the light source 42.

In other cases, for example, differential interference observation, dark field observation, and phase difference observation, cubes prepared in correspondence with these observation methods are attached to the illumination unit 41 in the same manner as described above, thereby coping with the respective observation methods.

This arrangement provides the same effects as those of the first embodiment. In addition, making the bright field cube 44 detachable with respect to the illumination unit 41 allows easy part replacement and maintenance/inspection, thereby providing a convenient microscope with good maintainability. Furthermore, there is no need to prepare various kinds of illumination units 41. Instead, this embodiment prepares cubes corresponding to the respective types of observation methods, and is configured to change only these cubes in accordance with the observation method to be used, thereby also providing an advantage in terms of cost.

### Third Embodiment

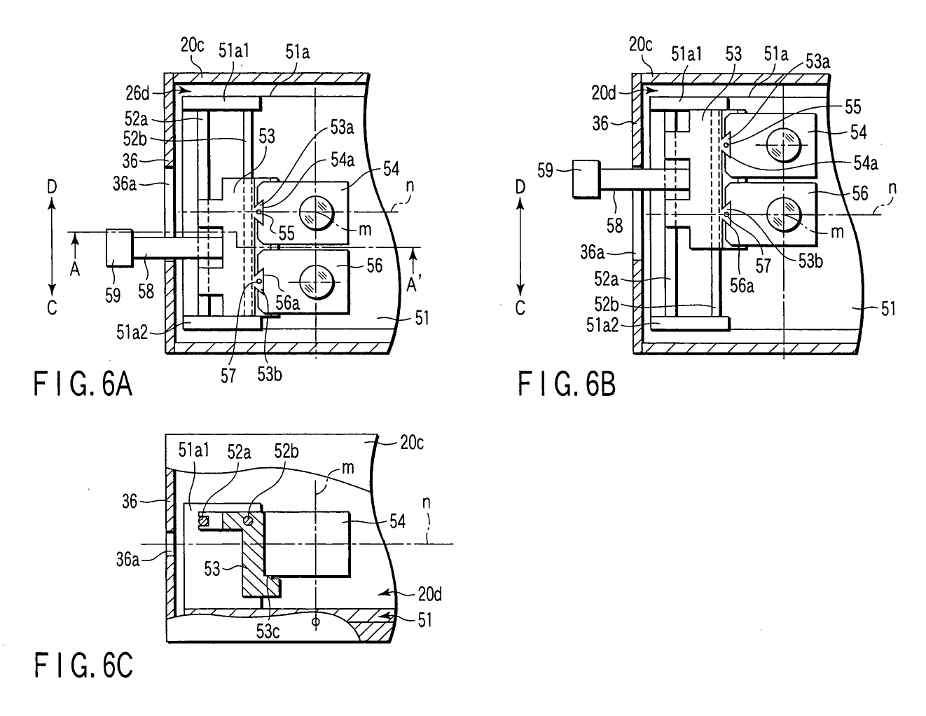

FIGS. 6A, 6B, and 6C show an illumination unit according to the third embodiment of the present invention. This illumination unit includes cubes to allow switching of bright field observation and differential interference observation. FIG. 6A is a top view showing part of the illumination unit at the time of bright field observation. FIG. 6B is a top view showing part of the illumination unit at the time of differential interference observation. FIG. 6C is a sectional view taken along a line A-A′ of the illumination unit in FIG. 6A. A description of the same part as that of the first embodiment described above will be omitted, and only different points between these embodiments will be mainly described with reference to FIGS. 6A, 6B, and 6C.

An illumination unit 51 has a frame body 51a that is inserted in and removed from an arm portion 20c. The frame body 51a is provided with a pair of protruding walls 51a1 and 51a2 facing each other in a direction perpendicular to an illumination optical path n. Optical path switching guides 52a and 52b are arranged between the support frames 51a1 and 51a2. The optical path switching guides 52a and 52b are parallelly arranged at a predetermined interval in a direction perpendicular to the illumination optical path n.

The optical path switching guides 52a and 52b have a cube holding member 53. The cube holding member 53 is allowed to linearly slide along the optical path switching guides 52a and 52b.

The cube holding member 53 is provided with male dovetails 53a and 53b side by side. A female dovetail 54a of a bright field cube 54 is fitted on one male dovetail 53a and is fixed with a detachable screw 55. A female dovetail 56a of a differential interference cube 56 is fitted on the other male dovetail 53b, and is fixed with a detachable screw 57. An abutment surface 53c positions the bright field cube 54 with respect to the cube holding member 53 (see FIG. 6C). The differential interference cube 56 is also positioned by an abutment surface (not shown) in the same manner as described above. The abutment surface 53c constitutes a positioning mechanism for positioning the bright field cube 54 and the differential interference cube 56. A technique of fixing the bright field cube 54 and the differential interference cube 56 by using the detachable screws 55 and 57 is the same technique as that described in the second embodiment.

The cube holding member 53 is provided with a console 58. The console 58 protrudes outside from a hole portion 36a formed in a cover 36 attached to the distal end of an arm portion 20c, and is provided with an optical path switching knob 59 at an end of the cube holding member. The optical path switching knob 59 is for sliding the cube holding member 53 along the optical path switching guides 52a and 52b so as to selectively position the bright field cube 54 or the differential interference cube 56 on an observation optical path m. The cube holding member 53 comes into contact with the support frame 51a1 or 51a2 to limit the sliding range of the cube holding member 53 and position the bright field cube 54 or the differential interference cube 56 on the observation optical path m. The cube holding member 53 and the optical path switching guides 52a and 52b constitute an observation optical path switching mechanism for selectively placing one of the bright field cube 54 and the differential interference cube 56 on the observation optical path m.

That is, while the cube holding member 53 is in contact with the support frame 51a2 upon movement of the optical path switching knob 59 in a direction from D to C (as shown in FIG. 6A), the bright field cube 54 is placed on an illumination optical path n and the observation optical path m, thereby allowing bright field observation. In contrast, while the cube holding member 53 is in contact with the support frame 51a1 upon movement of the optical path switching knob 59 in a direction from C to D (as shown in FIG. 6B), the differential interference cube 56 is placed on the illumination optical path n and the observation optical path m, thereby allowing differential interference observation.

The operation of the third embodiment having the above arrangement will be described next.

For bright field observation, the optical path switching knob 59 is moved in the direction from D to C to bring the cube holding member 53 into contact with the support frame 51a2 (see FIG. 6A). In this state, the bright field cube 54 is placed on the illumination optical path n and the observation optical path m, allowing bright field observation.

For switching the state of bright field observation to the state of differential interference observation, the optical path switching knob 59 is moved in the direction from C to D to bring the cube holding member 53 into contact with the support frame 51a1 (see FIG. 6B). In this state, the bright field cube 54 is completely out of the illumination optical path n and the observation optical path m, and the differential interference cube 56 is placed on the illumination optical path n and the observation optical path m, allowing differential interference observation.

The same applies to switching from the state of differential interference observation to the state of bright field observation.

This arrangement can therefore obtain the same effects as those of the second embodiment. In addition, since observation corresponding to each type of observation method is performed by only operating the optical path switching knob 59 to alternately switching arbitrary cubes, i.e., the bright field cube 54 and the differential interference cube 56, thereby providing a microscope with good work efficiency.

This embodiment has exemplified the bright field cube 54 and the differential interference cube 56 as cubes to be switched. It, however, suffices to use a combination of cubes used for other observation methods. In addition, the number of cubes is not limited to two and may be increased. Likewise, although not shown, the embodiment may prepare light sources corresponding to the respective types of observation methods and may switch and use the light sources in accordance with the observation methods to be used.

### Fourth Embodiment

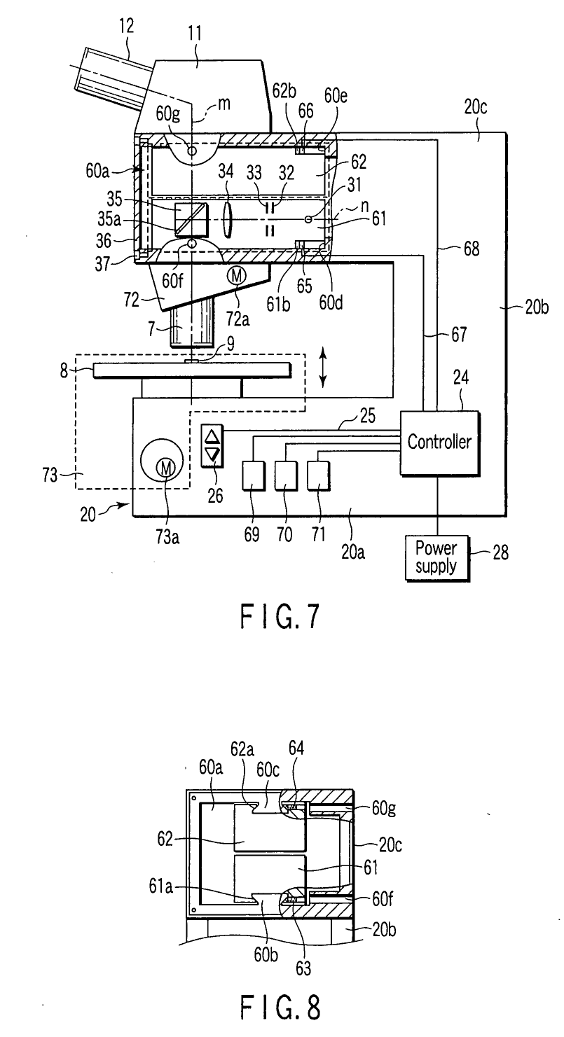

FIGS. 7 and 8 show a microscope according to the fourth embodiment of the present invention. The microscope includes two units, which the hollow portion of an arm portion incorporates. FIG. 7 is a side view of the microscope. FIG. 8 is a partial sectional view showing the front main part of the microscope. A description of the same part as that of the first embodiment described above will be omitted, and only different points between these embodiments will be mainly described with reference to FIGS. 7 and 8.

An arm portion 20c of a microscope body 20 has a hollow portion 60a large enough to accommodate an illumination unit 61 for bright field observation and an AF (autofocus) unit 62 for focus detection in a stacked state. The illumination unit 61 is similar to the illumination unit 21 described in the first embodiment. The AF unit 62 is an additional unit for automatically focusing on a sample 9, and has a general arrangement using a known technique.

Surfaces of the hollow portion 60a that face each other, i.e., the bottom surface and the upper surface in this case, respectively have male dovetails 60b and 60c provided along the central axis (illumination optical path n) of the hollow portion 60a (see FIG. 8). The illumination unit 61 is detachably attached to the male dovetail 60b. The illumination unit 61 is provided with a female dovetail 61a corresponding to the male dovetail 60b. The female dovetail 61a is fitted on the male dovetail 60b, so that the illumination unit 61 is and inserted in and removed from the hollow portion 60a by sliding operation. The female dovetail 61a and the male dovetail 60b constitute an inserting/removing mechanism for inserting/removing the illumination unit 61 in/from the arm portion 20c. Likewise, the AF unit 62 is detachably attached to the male dovetail 60c. The AF unit 62 is provided with a female dovetail 62a corresponding to the male dovetail 60c. The female dovetail 62a is fitted on the male dovetail 60c, so that the AF unit 62 is inserted in and removed from the hollow portion 60a by sliding operation. The female dovetail 62a and the male dovetail 60c constitute an additional inserting/removing mechanism for inserting/removing the AF unit 62 in/from the arm portion 20c.

The hollow portion 60a is provided with an abutment surface 60d and an abutment surface 60e corresponding to the illumination unit 61 and the AF unit 62. The illumination unit 61 and the AF unit 62 inserted in the hollow portion 60a are abutted against the abutment surface 60d and the abutment surface 60e, respectively, to be positioned. The abutment surface 60d and the abutment surface 60e constitute a positioning mechanism for positioning the illumination unit 61 and the AF unit 62. As in the first embodiment, the illumination unit 61 is fixed by threading a detachable screw 63 into the screw hole formed in the illumination unit 61 by using a tool (not shown) inserted through a hole portion 60f. Likewise, the AF unit 62 is fixed by threading a detachable screw 64 into the screw hole formed in the AF unit 62 by using a tool (not shown) inserted through a hole portion 60g. The detachable screw 63 and the screw hole formed in the illumination unit 61 constitute a fixing mechanism for fixing the illumination unit 61 to the arm portion 20c. The detachable screw 64 and the screw hole formed in the AF unit 62 constitute a fixing mechanism for fixing the AF unit 62 to the arm portion 20c.

The hollow portion 60a is provided with connector portions 65 and 66 near the abutment surfaces 60d and 60e. When the illumination unit 61 is abutted against the abutment surface 60d to be positioned, the connector portion 65 is connected to a connector portion 61b on the illumination unit 61 side. When the AF unit 62 is abutted against the abutment surface 60e to be positioned, the connector portion 66 is connected to a connector portion 62b on the AF unit 62 side. The connector portions 65 and 66 connect to a controller 24 through cables 67 and 68.

The controller 24 is connected to an AF ON/OFF switch 69, a nosepiece forward/reverse rotation designation switch 70, and a focusing portion raising/lowering designation switch 71. The controller 24 is also connected to a motor 72a of an electric nosepiece 72 and a motor 73a of an electric focusing portion 73 through cables (not shown).

The electric nosepiece 72 serves to hold objective lenses 7. The controller 24 drives the motor 72a in accordance with the operation of the nosepiece forward/reverse rotation designation switch 70, thereby automatically positioning the desired objective lens 7 on the optical path. In the electric focusing portion 73, the controller 24 drives the motor 73a in accordance with the operation of the focusing portion raising/lowering designation switch 71, thereby controlling the movement of a stage 8 on which a sample 9 is placed in a direction (Z direction) along an observation optical path m. The AF ON/OFF switch 69 serves to turn on/off the AF unit 62.

The remaining arrangement is the same as that of the first embodiment.

The operation of this embodiment having the above arrangement will be described next.

For manually focusing on the sample 9, the focusing portion raising/lowering designation switch 71 is operated. The controller 24 then drives the motor 73a to move the stage 8 in a direction (Z direction) along the observation optical path m to focus on the sample 9. For switching objective lenses by using the electric nosepiece 72, the nosepiece forward/reverse rotation designation switch 70 is operated. The controller 24 then drives the motor 72a to automatically position the desired objective lens 7 on the optical path.

For inserting/removing the illumination unit 61 and the AF unit 62 in/from the hollow portion 60a of the arm portion 20c, the female dovetail 61a of the illumination unit 61 is fitted on the male dovetail 60b, and the illumination unit 61 is slid with respect to the hollow portion 60a in this state. Likewise, with respect to the AF unit 62, the female dovetail 62a is fitted on the male dovetail 60c and the AF unit 62 is slid with respect to the hollow portion 60a in this state. When the illumination unit 61 is abutted against the abutment surface 60d to be positioned, the illumination unit 61 is connected to the controller 24 through the connector portions 61b and 65. When the AF unit 62 is abutted against the abutment surface 60e to be positioned, the AF unit 62 is connected to the controller 24 through the connector portions 62b and 66. When the AF ON/OFF switch 69 is turned on, automatic focus control is performed. When the AF ON/OFF switch 69 is turned off, automatic focus control is canceled.

This arrangement provides the same effects as those of the first embodiment. In addition, the length of the optical path through which light from the sample 9 is formed into an image on an eyepiece 12 is constant, and units such as the illumination unit 61 and the AF unit 62 are arranged in the constant optical path. In other words, even the arrangement in which units are stacked on each other does not change the optical path length. Thus, there is no chance that a shortage will occur in the marginal light amount of an observation image. Furthermore, since the optical path length does not change, the eyepoint height does not change. That is, this arrangement is good in ergonomic properties. In addition, since this arrangement reduces the weight of each unit as compared with a case wherein various kinds of units such as the AF unit 62 are prepared as external units, a lightweight microscope can be provided with rigidity being ensured.

In the fourth embodiment described above, the combination of the illumination unit 61 and the AF unit 62 is mounted in the hollow portion 60a of the arm portion 20c of the microscope body 20. However, the combination is not limited to this. For example, units corresponding to various types of observation methods and other types of units, in addition to the AF unit 62, may be selectively combined and mounted.

### <Modification>

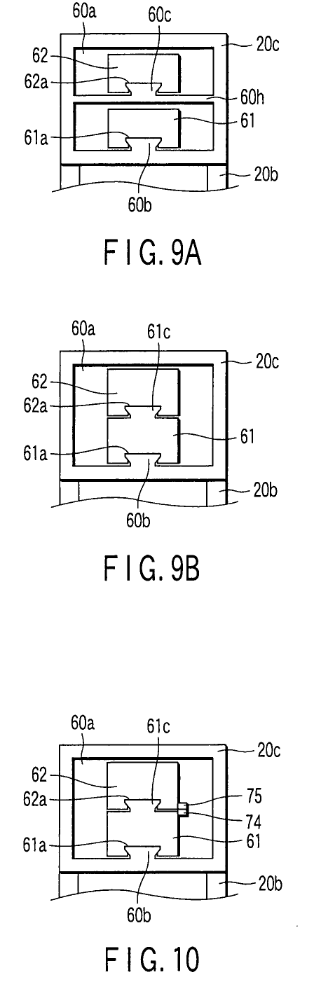

FIGS. 9A, 9B, and 10 show modifications of the microscope according to the fourth embodiment. These microscopes each include two units, which the hollow portion of an arm portion incorporates. A description of the same part as that of the fourth embodiment described above will be omitted, and only different points between the embodiment and the modifications will be mainly described with reference to FIGS. 9A, 9B, and 10.

In the microscope shown in FIG. 9A, the arm portion 20c is provided with a partition plate 60h that vertically divides the hollow portion 60a of the arm portion 20c into two sections. The bottom surfaces of the hollow portion 60a and partition plate 60h respectively have male dovetails 60b and 60c extending along the central axis (illumination optical path n) of the hollow portion 60a. The female dovetail 61a of the illumination unit 61 is fitted on the male dovetail 60b of the bottom surface of the hollow portion 60a, so that the illumination unit 61 is inserted in and removed from the space between the bottom surface of the hollow portion 60a and the partition plate 60h by sliding operation. Likewise, the female dovetail 62a of the AF unit 62 is fitted on the male dovetail 60c of the bottom surface of the partition plate 60h, so that the AF unit 62 is inserted in and removed from the space between the bottom surface of the partition plate 60h and the upper surface of the hollow portion 60a by sliding operation. The illumination unit 61 and the AF unit 62 are positioned in the respective spaces by the same technique as that in the fourth embodiment, and fixed with detachable screws (not shown). These units then connect to the controller through connector portions (not shown).

This arrangement provides the same effects as those of the fourth embodiment.

In the microscope shown in FIG. 9B, the bottom surface of the hollow portion 60a of the arm portion 20c is provided with the male dovetail 60b extending along the central axis (illumination optical path n) of the hollow portion 60a. The female dovetail 61a of the illumination unit 61 is fitted on the male dovetail 60b of the bottom surface of the hollow portion 60a, so that the illumination unit 61 is inserted in and removed from the space between the bottom surface of the hollow portion 60a and the partition plate 60h by sliding operation. The upper surface of the illumination unit 61 is provided with a male dovetail 61c extending along the central axis (illumination optical path n) of the hollow portion 60a. The female dovetail 62a of the AF unit 62 is fitted on the male dovetail 61c of the illumination unit 61, so that the AF unit 62 is inserted in and removed from the male dovetail 61c of the illumination unit 61 by sliding operation. The illumination unit 61 and the AF unit 62 are positioned inside the hollow portion 60a by the same technique as that in the fourth embodiment, and fixed with detachable screws (not shown). These units are then connected to the controller through connector portions (not shown).

This arrangement provides the same effects as those of the fourth embodiment.

FIG. 10 shows another modification of the microscope shown in FIG. 9B. In the microscope shown in FIG. 10, while the illumination unit 61 and the AF unit 62 are positioned by abutment surfaces (not shown) in the hollow portion 60a and fixed with detachable screws (not shown), a connector portion 75 provided on an outer portion of the AF unit 62 is connected to a connector portion 74 provided on an outer portion of the illumination unit 61. The illumination unit 61 is connected to the controller through a connector portion (not shown). The connector portion 74 is connected to the controller (not shown) through the illumination unit 61. The AF unit 62 is connected to the controller (not shown) through the connector portion 75 and the connector portion 74 connected to the connector portion 75. This arrangement also connects both the illumination unit 61 and the AF unit 62 to the controller (not shown), and provides the same effects as those of the fourth embodiment.

### Fifth Embodiment

FIG. 11 is a partial sectional view showing the front main part of a microscope according to the fifth embodiment. A description of the same part as that of the first embodiment described above will be omitted, and only different points between these embodiments will be mainly described with reference to FIG. 11.

As in the first embodiment, an arm portion 90 has inside a hollow portion 90a. The front wall of the arm portion 90 is provided with an opening portion. A side wall 90b of the arm portion 90 is provided with a female dovetail 90c. The female dovetail 90c extends in the longitudinal direction of the hollow portion 90a on the side surface of the hollow portion 90a. An illumination unit 91 is provided with a male dovetail 91a. The female dovetail 90c is fitted on the male dovetail 91a, so that the illumination unit 91 is inserted in and removed from the hollow portion 90a through the opening portion by sliding operation. That is, the male dovetail 91a of the illumination unit 91 and the female dovetail 90c of the arm portion 90 constitute an inserting/removing mechanism for inserting/removing the arm portion 90 in/from the illumination unit 91.

As in the first embodiment, the illumination unit 91 is positioned by a positioning portion such as a stepped portion (not shown) in the hollow portion 90a, and fixed by a fixing member such as a detachable screw (not shown), so as to be connected to the controller through a connector portion (not shown).

This arrangement provides the same effects as those of the first embodiment. In addition, providing the inserting/removing mechanism on the side surface of the hollow portion 90a reduces the sizes of the outer shapes of the arm portion and illumination unit in an observation optical path m, thereby achieving further reductions in the weight and size of the overall microscope body.

In this embodiment, one side wall inside the hollow portion 90a is provided with one inserting/removing mechanism comprising the female dovetail 90c and the male dovetail 91a. However, the two side walls inside the hollow portion 90a may be provided with two similar inserting/removing mechanisms. In this case, the illumination unit 91 is reliably fixed in the hollow portion 90a with higher positioning accuracy when the illumination unit 91 is inserted into the hollow portion 90a.

### <First Modification of Fifth Embodiment>

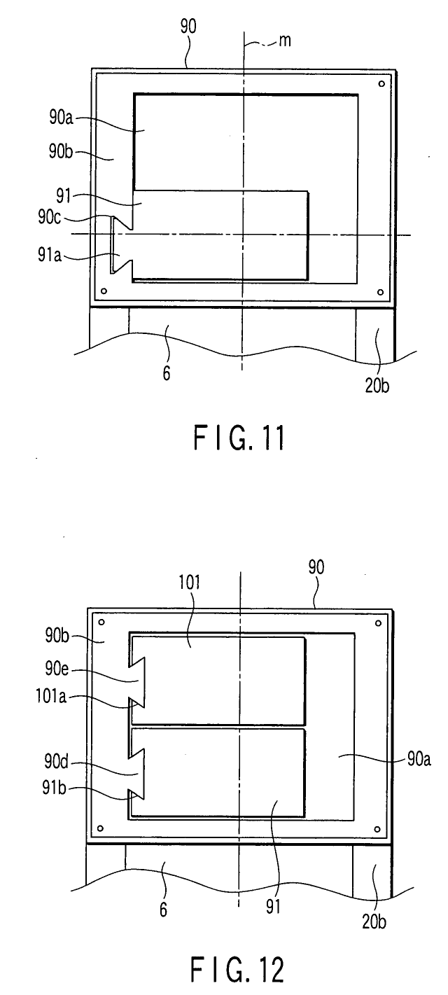

FIG. 12 shows the schematic arrangement of a modification of the microscope according to the fifth embodiment. As in the fourth embodiment, this microscope is configured to insert/remove different kinds of illumination units, an AF unit, and the like, in addition to the illumination unit 91, in/from the hollow portion 90a. That is, this microscope allows selective addition of units in addition to the illumination unit 91. A description of the same part as that of the fifth embodiment described above will be omitted, and only different points between the embodiment and the modification will be mainly described with reference to FIG. 12.

The side wall 90b of the arm portion 90 is provided with two male dovetails 90d and 90e. The male dovetails 90d and 90e extend in the hollow portion 90a in its longitudinal direction on the side surface of the hollow portion 90a. The illumination unit 91 and an illumination unit 101 are respectively provided with female dovetails 91b and 101a. The male dovetails 90d and 90e and the female dovetails 91b and 101a respectively constitute inserting/removing mechanisms for inserting/removing the illumination units 91 and 101 in/from the arm portion 90. The female dovetail 91b is fitted on the male dovetail 90d, so that the illumination unit 91 is inserted in and removed from the hollow portion 90a by sliding operation. Likewise, the female dovetail 101a is fitted on the male dovetail 90e, so that the illumination unit 101 is inserted in and removed from the hollow portion 90a by sliding operation. The inserting/removing mechanism comprising the male dovetail 90d and the female dovetail 91b is the same structure as that of the inserting/removing mechanism comprising the male dovetail 90e and the female dovetail 101a. This allows the positions of the illumination units 91 and 101 to be interchanged. The microscope may have three or more inserting/removing mechanisms as well as two inserting/removing mechanisms. In addition, the hollow portion 90a of the arm portion 90 may incorporate a combination of three or more units, e.g., illumination units, an AF unit, and other units.

The above arrangement provides the same effects as those of the fifth embodiment, and also allows a combination of units, e.g., illumination units corresponding to the respective types of observation methods, an AF unit, and other units to be incorporated, constructing a microscope system with high functionality.

### <Second Modification of Fifth Embodiment>

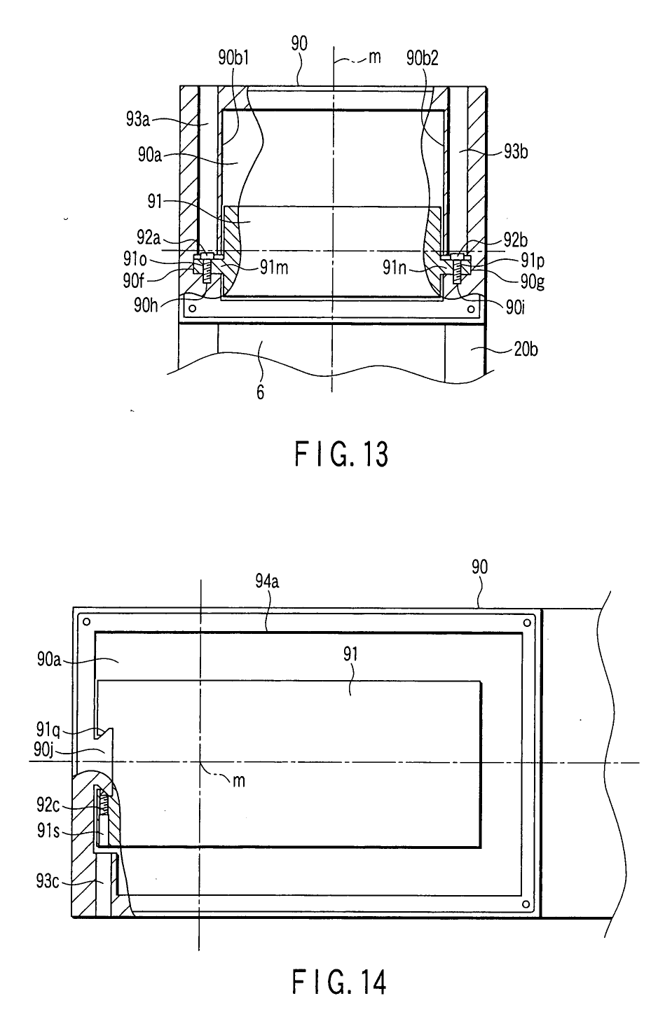

FIG. 13 shows the schematic arrangement of another modification of the microscope according to the fifth embodiment. In this microscope, a slide guide mechanism forms an inserting/removing mechanism for inserting/removing the illumination unit 91 in/from the arm portion 90 instead of the dovetail mechanism comprising the female dovetail 90c and the male dovetail 91a shown in FIG. 11 in the fifth embodiment. A description of the same part as that of the fifth embodiment described above will be omitted, and only different points between the embodiment and the modification will be mainly described with reference to FIG. 13.

Side walls 90b1 and 90b2 inside the arm portion 90 have fitting grooves 90f and 90g extending in the hollow portion 90a of the arm portion 90 in the longitudinal direction of the arm portion 90 (a direction perpendicular to the drawing surface). Both side surfaces of the illumination unit 91 have protruding portions 91m and 91n extending in the longitudinal direction of the illumination unit 91. The protruding portions 91m and 91n is fitted in the fitting grooves 90f and 90g, respectively, so that the illumination unit 91 is inserted in and removed from the hollow portion 90a by sliding operation. The fitting grooves 90f and 90g of the arm portion 90 and the protruding portions 91m and 91n of the illumination unit 91 constitute a slide guide mechanisms as an inserting/removing mechanism.

The protruding portions 91m and 91n respectively have through holes 91o and 91p extending in the direction of an observation optical path m. The side walls 90b1 and 90b2 have screw holes 90h and 90i extending into the fitting grooves 90f and 90g from their lower surfaces in the direction of the observation optical path m. The side walls 90b1 and 90b2 respectively have through holes 93a and 93b extending in the direction of the observation optical path m through the upper surfaces of the side walls 90b1 and 90b2 and the upper surfaces of the fitting grooves 90f and 90g. The through holes 93a and 93b and the screw holes 90h and 90i are respectively formed at positions to align with the through holes 91o and 91p of the protruding portions 91m and 91n of the illumination unit 91 inserted and positioned in the hollow portion 90a. The through holes 93a and 93b are for the insertion of detachable screws 92a and 92b as fixtures and a tool (not shown) for fastening the detachable screws 92a and 92b, and have inner diameters larger than the diameters of the detachable screws 92a and 92b. The detachable screws 92a and 92b, through holes 91o and 91p, and screw holes 90h and 90i constitute a fixing mechanism for fixing the illumination unit 91 to the arm portion 90.

The protruding portions 91m and 91n are respectively fitted in the fitting grooves 90f and 90g, and the illumination unit 91 is inserted into the hollow portion 90a and positioned by a positioning portion such as a stepped portion (not shown). Inserting the detachable screws 92a and 92b into the through holes 91o and 91p and threading the detachable screws 92a and 92b into the screw holes 90h and 90i by using a tool (not shown) fix the illumination unit 91 in the hollow portion 90a of the arm portion 90.

An inserting/removing mechanism to be used is not limited to the one described in this modification, and another known guide mechanism may be used to this embodiment.

### <Third Modification of Fifth Embodiment>

FIG. 14 shows the schematic arrangement of still another modification of the microscope according to the fifth embodiment. In the fifth embodiment, an illumination unit is inserted and removed through the front surface of the arm portion of the microscope body. In this modification, an illumination unit is inserted and removed through the upper surface of the arm portion of the microscope body. A description of the same part as that of the fifth embodiment described above will be omitted, and only different points between the embodiment and the modification will be mainly described with reference to FIG. 14.

FIG. 14 is a view showing the arm portion 90 as viewed from above. The arm portion 90 has inside the hollow portion 90a, and the upper surface wall of the arm portion 90 is provided with an opening portion 94a. The hollow portion 90a of the arm portion 90 is provided with a male dovetail 90j. The male dovetail 90j extends in a direction parallel to the observation optical path m. The illumination unit 91 is provided with a female dovetail 91q. The female dovetail 91q is fitted on the male dovetail 90j, so that the illumination unit 91 is inserted in and removed from the hollow portion 90a through the opening portion 94a formed in the upper surface wall of the arm portion 90 by sliding operation. That is, the male dovetail 90j and the female dovetail 91q constitute an inserting/removing mechanism for inserting/removing the illumination unit 91 in/from the arm portion 90.

The illumination unit 91 is provided with a screw hole 91s extending through between a side surface of the illumination unit 91 and a side surface of the female dovetail 91q. The arm portion 90 is provided with a through hole 93c formed at a position to align with the screw hole 91s of the illumination unit 91 that is inserted and positioned in the hollow portion 90a. The through hole 93c is for the insertion of a detachable screw 92c as a fastener and a tool (not shown) for fastening the detachable screw 92c, and has an inner diameter larger than the diameter of the detachable screw 92c. The detachable screw 92c and the screw hole 91s constitute a fixing mechanism for fixing the illumination unit 91 in the arm portion 90.

The female dovetail 91q is fitted on the male dovetail 90j, so that the illumination unit 91 is inserted in the hollow portion 90a to be positioned by a positioning portion such as a stepped portion (not shown). In addition, threading the detachable screw 92c into the screw hole 91s by using a tool (not shown) through the through hole 93c fix the illumination unit 91 in the hollow portion 90a of the arm portion 90.

A fixing technique to be used is not limited to this, and another technique may be applied to this embodiment. In addition, it is preferable to detachably mount a cover member on the arm portion 90 to cover the opening portion 94a.

### <Fourth Modification of Fifth Embodiment>

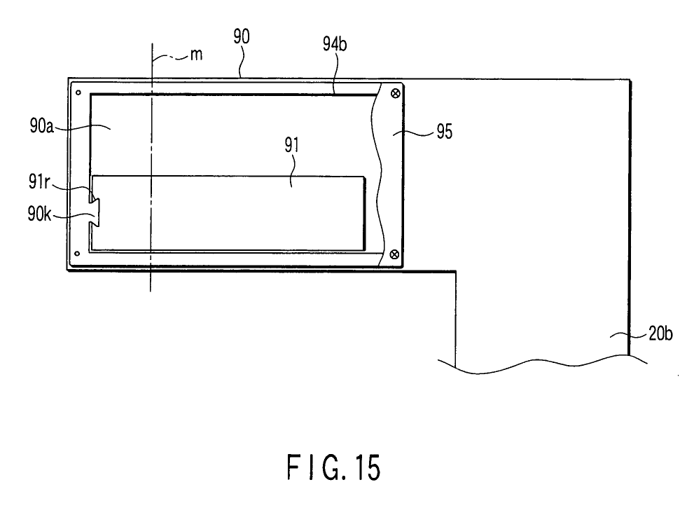

FIG. 15 shows the schematic arrangement of still another modification of the microscope according to the fifth embodiment. In the fifth embodiment described above, an illumination unit is inserted and removed through the front surface of the arm portion of the microscope body. In this modification, an illumination unit is inserted and removed through a side surface of the arm portion of the microscope body. A description of the same part as that of the fifth embodiment described above will be omitted, and only different points between the embodiment and the modification will be mainly described with reference to FIG. 15.

FIG. 15 is a view showing the arm portion 90 as viewed from a side surface. A side wall of the arm portion 90 is provided with an opening portion 94b. The opening portion 94b may be formed in only at least one of two side walls of the arm portion 90. The arm portion 90 is provided with a male dovetail 90k. The male dovetail 90k extends in a direction perpendicular to the observation optical path m on the hollow portion 90a of the arm portion 90. The illumination unit 91 is provided with a female dovetail 91r. The female dovetail 91r is fitted on the male dovetail 90k, so that the illumination unit 91 is inserted in and removed from the hollow portion 90a through the opening portion 94b formed in the side wall of the arm portion 90 by sliding operation. That is, the male dovetail 90k and the female dovetail 91r constitute an inserting/removing mechanism for inserting/removing the illumination unit 91 in/from the arm portion 90. As in the fifth embodiment, it suffices to allow the illumination unit 91 and the arm portion 90 to be fixed by fixtures (not shown). A cover member 95 is detachably mounted on the arm portion 90 to cover the opening portion 94b.

### Sixth Embodiment

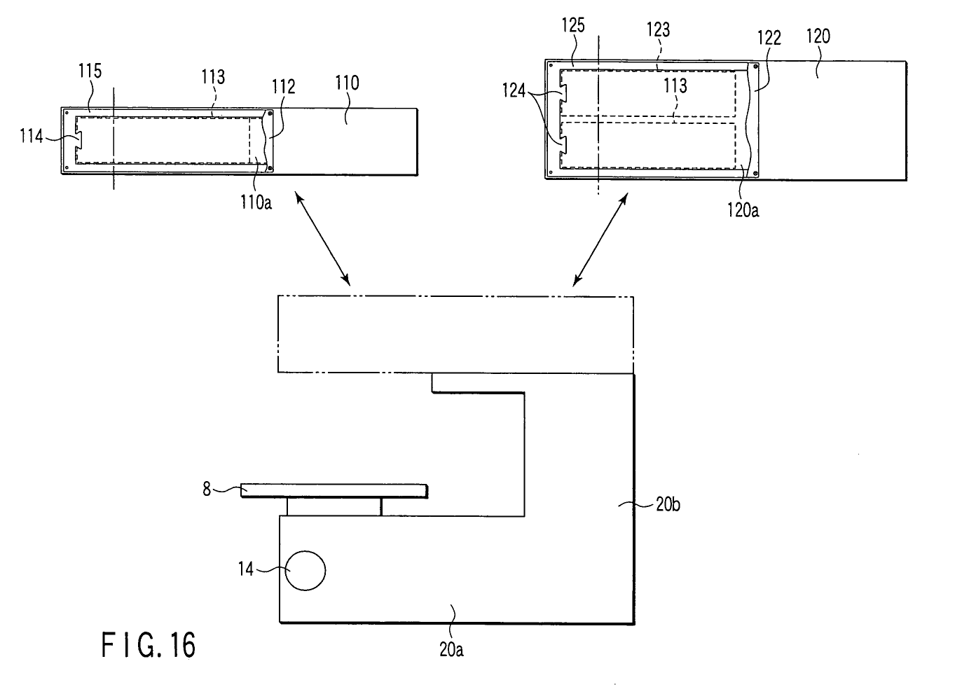

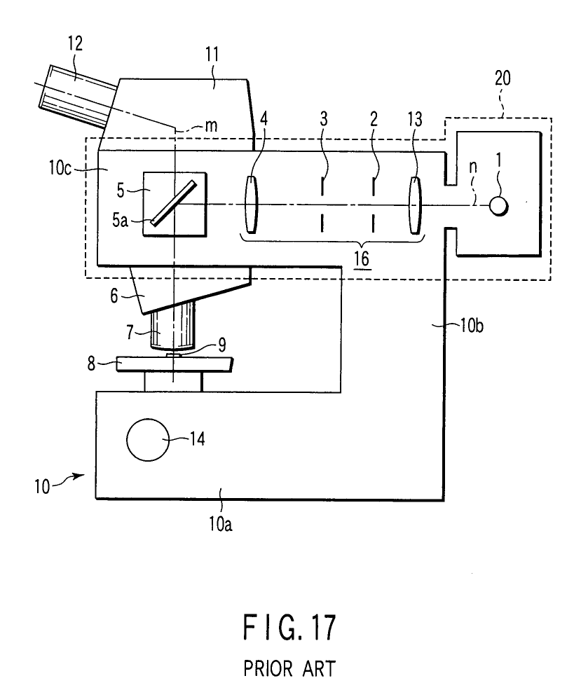

FIG. 16 is a side view showing the schematic arrangement of a microscope according to the sixth embodiment. A description of the same part as that of the first embodiment described above will be omitted, and only different points between these embodiments will be mainly described with reference to FIG. 16. In this embodiment, the arm portion of the above microscope body is configured to be detachably mounted on a main body comprising a base portion 20a and a support portion 20b.

An arm frame body 110 is detachably mounted on the support portion 20b with a fixing member (not shown). The arm frame body 110 has inside a hollow portion. A side wall of the arm frame body 110 is provided with an opening portion 115. A cover member 112 is amounted on a side surface of the arm frame body 110 so as to cover the opening portion 115. The cover member 112 is detachably mounted on a side surface of the arm frame body with a fastener such as a screw. An inserting/removing mechanism 114 detachably mounts an illumination unit 113 in a hollow portion 110a of the arm frame body 110. As the inserting/removing mechanism 114, the inserting/removing mechanism described in each of the above embodiments may be used. The inserting/removing mechanism 114 is not limited to the dovetail mechanism and slide guide mechanism described in the above embodiments, and other known guide mechanisms may be applied.

Like the arm frame body 110, an arm frame body 120 is detachably mounted on the support portion 20b with a fixing member (not shown). The arm frame body 120 has inside a hollow portion. A side wall of the arm frame body 120 is provided with an opening portion 125. A cover member 122 is mounted on a side surface of the arm frame body 120 so as to cover the opening portion 125. The cover member 122 is detachably mounted on a side surface of the arm frame body with a screw. An inserting/removing mechanism 124 detachably mounts an illumination unit 113 or 123 in a hollow portion 120a of the arm frame body 120. It suffices to apply the inserting/removing mechanism described in the above embodiment as the inserting/removing mechanism 124. The inserting/removing mechanism 114 is not limited to the dovetail mechanism and slide guide mechanism described in the above embodiments, and other known guide mechanisms may be applied

A fixing mechanism (not shown) detachably attaches the arm frame bodies 110 and 120 to the support portion 20b. As a fixing mechanism, it suffices to apply any known fixing technique, e.g., fixing by fitting with a dovetail mechanism or fixing with a bolt.

According to this embodiment, there is provided a microscope with high system performance by selecting one of different types of arm portion frame bodies in accordance with the application of microscope observation.

The present invention is not limited to the above embodiments, and the embodiments may be variously modified within the spirit and scope of the present invention. For example, according to the above embodiments, various kinds of units, e.g., an illumination unit and an AF unit, are inserted in and removed from the hollow portion in the arm portion from the distal end side, side surface side, or upper side of the arm portion. However, such a unit may be inserted in and removed from the hollow portion of the arm portion from the lower surface side or rear end side of the arm portion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A microscope comprising:
an objective lens;
a microscope body to support the objective lens, having inside a hollow portion;
an illumination unit including an illumination optical system to apply illumination light from a light source to a sample in cooperation with the objective lens; and
an inserting/removing mechanism to insert/remove the illumination unit in/from the hollow portion.

2. A microscope according to claim 1, wherein the illumination unit is selected from illumination units respectively including illumination optical systems corresponding to various kinds of observation methods.

3. A microscope according to claim 2, wherein the illumination units include illumination units including illumination optical systems respectively corresponding to a bright field observation method, a dark field observation method, a differential interference observation method, a phase difference observation method, and a fluorescence observation method.

4. A microscope according to claim 1, further comprising a positioning mechanism to position the illumination unit.

5. A microscope according to claim 4, further comprising a fixing mechanism to fix the illumination unit to the microscope body.

6. A microscope according to claim 1, wherein the illumination unit includes a frame body to be inserted in and removed from the hollow portion, and a cube mounted on the frame body.

7. A microscope according to claim 6, wherein the illumination unit further includes an inserting/removing mechanism to insert/remove the cube in/from the frame body.

8. A microscope according to claim 7, wherein the cube is selected from cubes corresponding to various kinds of observation methods.

9. A microscope according to claim 6, wherein the illumination unit includes cubes mounted on the frame body and an observation optical path switching mechanism to selectively place one of the cubes on an observation optical path.

10. A microscope according to claim 1, wherein the inserting/removing mechanism comprises a dovetail mechanism.

11. A microscope according to claim 1, wherein the inserting/removing mechanism comprises a slide guide mechanism.

12. A microscope according to claim 1, further comprising an additional unit and an additional inserting/removing mechanism to insert/remove the additional unit in/from the hollow portion.

13. A microscope according to claim 12, wherein the additional unit comprises an autofocus unit.

14. A microscope according to claim 12, wherein the inserting/removing mechanism is the same structure as that of the additional inserting/removing mechanism.

15. A microscope according to claim 1, wherein the microscope body comprises a frame body having inside the hollow portion, and a remaining main body, and the frame body is detachable with respect to the main body.

16. A microscope according to claim 15, wherein the frame body is selected from frame bodies on which illumination units corresponding various kinds of observation methods are mounted.

17. A microscope according to claim 1, wherein the light source comprises a semiconductor light-emitting element.

18. A microscope according to claim 1, wherein a microscope body includes a base, a support extending upward from the base, and an arm horizontally extending from the support, and the hollow portion is formed in the arm.

19. A microscope comprising:
a stage on which a sample is placed;
an objective lens facing the stage;
a microscope body including a base portion to support the stage, a support portion extending upward from the base portion, and an arm portion horizontally extending from the support portion, the arm portion supporting the objective lens and having inside a hollow portion;
an illumination unit including an illumination optical system to apply illumination light from a light source to a sample in cooperation with the objective lens; and
an inserting/removing mechanism to insert/remove the illumination unit in/from the hollow portion.
